(19) United States
(12) Patent Application Publication
(10) Pub. No.: US 2020/0292192 A1
(43) Pub. Date: Sep. 17, 2020

(54) BLOWER PROPERTIES USED FOR USER WARNING

(71) Applicant: JOHNSON CONTROLS TECHNOLOGY COMPANY, Auburn Hills, MI (US)

(72) Inventors: Andrew Michael BOYD, Wichita, KS (US); Madhuka Manuranga Jayarathne, Wichita, KS (US); Thomas D. Chase, Wichita, KS (US); Theresa N. Gillette, Rose Hill, KS (US)

(21) Appl. No.: 16/591,205

(22) Filed: Oct. 2, 2019

Related U.S. Application Data
(60) Provisional application No. 62/817,831, filed on Mar. 13, 2019.

(51) Int. Cl. F24F 11/39; F24F 11/52; F24F 11/65; F24F 11/64; B01D 46/00; B01D 46/42; B01D 46/46

(52) U.S. Cl. CPC F24F 11/39; F24F 11/52; F24F 11/65; F24F 11/64; B01D 2279/50; B01D 46/429; B01D 46/4263; B01D 46/46; B01D 46/0086

(57) ABSTRACT

A climate control unit (e.g., for a residential building) may include a heat exchanger, a blower that circulates air from a return duct, across the heat exchanger, to a supply duct, and a filter that cleans the air before entering the heat exchanger. The effectiveness and/or efficiency of the filter may decrease as the filter collects particles. The climate control unit may include a controller configured to set a baseline measurement according to measurements of a blower property after a reset event. The controller may be configured to measure a deviation of the blower property from the baseline measurement of the blower property. The controller may be configured to generate a status notification in response to the deviation satisfying a threshold. The status notification may indicate that the filter should be changed.

### CLAIM OF PRIORITY UNDER 35 U.S.C. § 119

This application claims priority to U.S. Provisional Application No. 62/817,831 titled “BLOWER PROPERTIES USED FOR USER WARNING,” filed Mar. 13, 2019, which is assigned to the assignee hereof, and incorporated herein by reference in its entirety.

### BACKGROUND

Residential climate control systems that combine heating and air conditioning often include one or more replaceable filters. During use, these filters collect particles and prevent the particles from being circulated through the climate control system. Over time, the filters become clogged and may reduce the efficiency of the climate control system by restricting air flow.

Typically, filters have a lifespan of three months and the user is instructed to change the filter based on the lifespan. Some climate control systems may include a timer that monitors the lifespan and provides a notification to a user to change the filter. Such notifications, however, are based on time of installation of the filter and do not reflect the actual condition of the filter. For example, if the filter becomes clogged early due to high levels of particles, a timer-based notification would not indicate that the filter should be changed. Conversely, if the system is in an unusually clean environment, a timer-based notification may indicate that the filter needs to be changed long before it is actually necessary.

In view of the foregoing, systems to improve notifications regarding a climate control system filter are desirable.

### SUMMARY

In an aspect, the present disclosure provides a climate control unit (e.g., for a residential building) may include a heat exchanger, a blower that circulates air from a return duct or external vent, across the heat exchanger, to a supply duct, and a filter that cleans the air before entering the heat exchanger. The effectiveness and/or efficiency of the filter may decrease as the filter collects particles. The climate control unit may include a controller configured to set a baseline measurement of a blower property according to measurements of the blower property after a reset event. The controller may be configured to measure a deviation of the blower property from the baseline measurement of the blower property. The controller may be configured to generate a status notification in response to the deviation satisfying a threshold. The status notification may indicate that the filter should be changed. The climate control system may also be referred to as a heating, ventilation, and air conditioning (HVAC) system or HVAC unit.

In another aspect, the disclosure provides a method of controlling a climate control system.

The method may include setting a baseline measurement of a blower property according to measurements of the blower property after a reset event. The method may include measuring a deviation of the blower property from the baseline measurement of the blower property. The method may include generating a status notification in response to the deviation satisfying a threshold.

In another aspect, the disclosure provides a controller for a climate control system. The controller may include a memory storing computer-executable instructions and a processor communicatively coupled with the memory to execute the instructions. The processor may be configured to set a baseline measurement of a blower property according to measurements of the blower property after a reset event. The processor may be configured to measure a deviation of the blower property from the baseline measurement of the blower property. The processor may be configured to generate a status notification in response to the deviation satisfying a threshold.

### BRIEF DESCRIPTION OF THE DRAWINGS

FIG. 1 is a schematic diagram of an example HVAC system including a HVAC unit having a controller configured to communicate with a remote user device.

FIG. 2 is flowchart showing an example method of controlling an HVAC system to generate a notification regarding a filter.

FIG. 3 is a schematic diagram of an example HVAC unit.

FIG. 4 is a schematic diagram of an example remote user device.

### DESCRIPTION

The present disclosure provides a climate control system (also referred to as a heating, ventilation, and air conditioning (HVAC) system) that provides notifications regarding a filter status, and a controller and method for operating the climate control system. The notifications may be based on detected changes in blower properties during operation. For example, as an HVAC filter is used and collects particles, the filter may become clogged and increase resistance to airflow. Accordingly, the blower wattage or current may increase to maintain airflow volume. As another example, if the filter were to tear, the airflow may increase and the blower wattage or current may decrease. In order to detect such changes, the controller of the climate control system may record baseline properties of the blower. The controller may then compare measurements of the properties of the blower during operation to the baseline measurement. The controller may generate a status notification based on a deviation from the baseline measurement. For example, if a deviation of a measurement during operation from the baseline measurement satisfies a threshold, the controller may generate the status notification, which may be provided to a user as an indication on a user interface, or provided to a remote user device.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

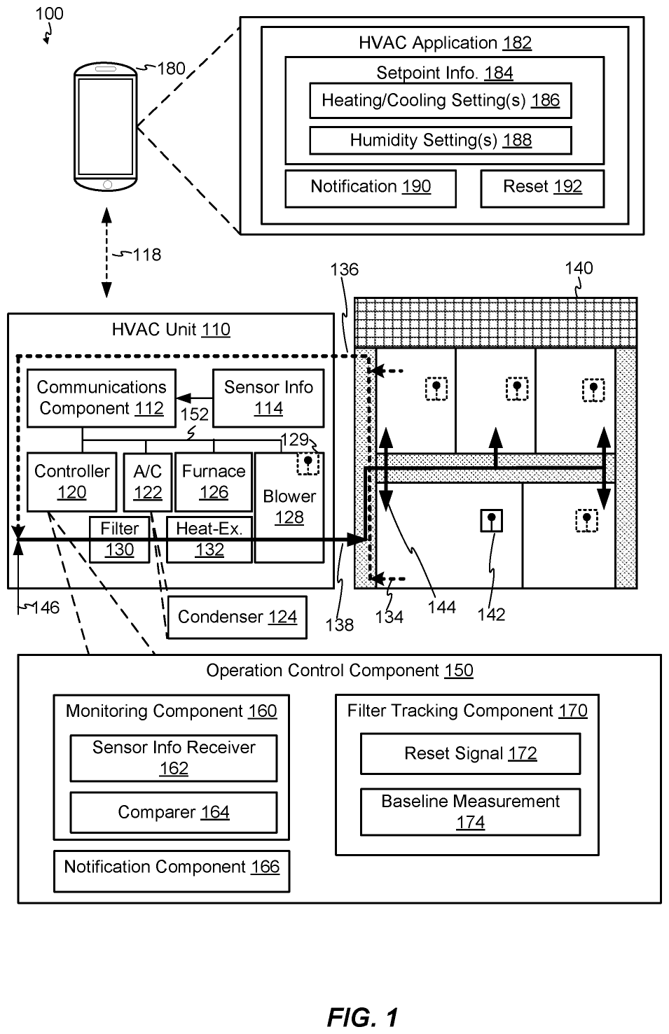

Referring to FIG. 1, an HVAC system 100 for a building 140 is disclosed. The HVAC system 100 may include an HVAC unit 110 configured to control an ambient condition of the one or more rooms of the building 140 based on information from one or more sensors 142 and a remote user device 180. In an example, an ambient condition may be a temperature or a humidity level. As shown by FIG. 1, the HVAC unit 110 may be external to the building 140. In an aspect, one or more components (e.g., air conditioning (A/C) unit 122, furnace 126, blower 128, communications component 112, or controller 120) may be located in different locations including inside the building 140. The building may be a home, office or any other structure that includes uses an HVAC system for controlling one or more ambient conditions of the structure.

In an aspect, the HVAC system 100 may include supply ducts 138 and return ducts 136 installed within the building 140 and coupled with the HVAC unit 110. The supply ducts 138 may supply air to the building 140, and the return ducts 136 may return air from the building 140. The supply ducts 138 may receive supply air through one or more of intakes 146 that provide outside air to the HVAC system 100 and/or may recycle return air from the return ducts 136. The supply ducts 138 may output the supply air at one or more of the rooms of the building 140 via one or more supply vents 144. The return ducts 136 may receive return air from the building 140 via one or more return vents 134 to balance air within the building 140.

The HVAC unit 110 may include one or more of an air conditioning (A/C) unit 122, a furnace 126, a blower 128, a humidifier/dehumidifier, or any other component (e.g., heat pump) for adjusting an ambient condition of a room of the building 140. The A/C unit 122 may be configured to cool the supply air by passing the supply air through or around one or more cooled pipes (e.g., chiller pipes) or through a heat exchanger 132 to lower a temperature of the supply air. The A/C unit 122 may include a condenser 124 located external to the HVAC unit 110 to cool a cooling fluid within the cooled pipes. The furnace 126 may be configured to warm the supply air by passing the supply air through or around one or more warmed pipes (e.g., heating coils) or through the heat exchanger 132 to raise the temperature of the supply air. The blower 128 may be configured to blow the supply air through the supply ducts 138 to the building 140 and pull the return air from the building 140. In an aspect, the HVAC unit 110 may include a filter 130 positioned within a pathway of the HVAC unit 110, for example in the supply ducts 138. For instance, the filter 130 may be located prior to the heat exchanger 132. Air entering the heat exchanger 132 may first pass through the filter 130, which removes particles (e.g., dust, pollen, hair) from the air. The blower 128 may include a blower sensor 129 that measures one or more properties of the blower 128. For example, the blower sensor 129 may be a sensor (e.g., a multimeter) that measures a wattage or current of the blower 128, or any other device that may provide such a measurement. As another example, the blower sensor 129 may measure a pulse width of a control signal for the blower 128. In yet another example, the blower sensor 129 may measure a speed (e.g., in revolutions per minute (RPM) of the blower 128. The filter tracking component 170 may store the measured blower property as the baseline measurement 174.

The HVAC unit 110 may include a communications component 112 configured to communicate with the one or more sensors 142 and/or the remote user device 180. In an aspect, the communications component 112 may communicate with the one or more sensors 142 and/or the remote user device 180 via one or more communications links 118. In an example, the communications component 112 may include one or more antennas, processors, modems, radio frequency components, and/or circuitry for communicating with the sensor 142 and/or the remote user device 180. The one or more communications links 118 may be wired or wireless communication links.

The HVAC system 100 may also include the sensors 142 located within one or more rooms of the building 140 and/or within or near the supply vents 144. A sensor 142 may be configured to detect an ambient condition such as a temperature or a humidity of the room where the sensor 142 is located. Each of the sensors 142 may provide sensor information (“info”) 114 to the HVAC unit 110. Examples of a sensor 142 may include a temperature sensor, a humidity sensor, or any sensor configured to detect an ambient condition of one or more rooms of the building 140.

The HVAC system 100 may also include the remote user device 180 configured to communicate with the HVAC unit 110. The remote user device 180 may include an HVAC application 182 configured to display, adjust, and store setpoint information (“info”) 184 indicating desired user settings for one or more rooms of the building 140. In an example, the setpoint information 184 may include heating/cooling settings 186 indicating one or more desired temperatures (e.g., minimum and/or maximum room temperatures) for one or more rooms of the building and/or humidity settings 188 indicating a desired humidity level for one or more rooms of the building 140. The remote user device 180 may provide the setpoint information 184 to the HVAC unit 110. Examples of a remote user device 180 may include a mobile device, a cellular phone, a smart phone, a personal digital assistant (PDA), a smart speaker, a home assistant, a wireless modem, a wireless communication device, a handheld device, a tablet computer, a laptop computer, a cordless phone, a smart watch, an entertainment device, an Internet of Things (IoT) device, or any device capable of communicating with the HVAC unit 110. A smart speaker may include, for example, an Echo® device available from Amazon, Inc. of Seattle, Wash., a Google Home® device available from Google, Inc. of Mountain View, Calif., or other similar devices. The HVAC application 182 may include a voice interface that response to voice commands.

The HVAC unit 110 may also include a controller 120 configured to control the A/C unit 122, the furnace 126, and the blower 128 based on the sensor information 114 received from the sensor 142 and the setpoint information 184 received from the remote user device 180. The controller 120 may communicate with the communications component 112, the A/C unit 122, the furnace 126, and/or the blower 128 via a communications bus 152. The controller 120 may include logic to determine when to initiate the blower 128 along with the A/C unit 122 and/or the furnace 126 based on the sensor information 114 and the setpoint information 184. The controller 120 may also include logic to determine a time and/or a speed to run the blower 128 along with a time or power level to run the A/C unit 122 and/or the furnace 126 based on the sensor information 114 and the setpoint information 184.

In an aspect, the controller 120 may include an operation control component 150 that monitors a status of the filter 130 and may generate a notification to a user regarding the status of the filter 130. The operation control component 150 may include a monitoring component 160 that receives sensor information 114 at a sensor information receiver 162 and compares the received sensor information 114 at a comparer 164. The operation control component 150 may include a filter tracking component 170 that tracks one or more properties for the filter 130. The filter tracking component 170 may receive a reset signal 172 indicating that a new filter 130 has been installed. The filter tracking component 170 may take a baseline measurement 174 using the monitoring component 160 and store the baseline measurement 174 for later comparison. For example, the comparer 164 may compare new measurements during operation to the baseline measurement 174. For instance, the comparer 164 may determine a deviation of a measurement from the baseline measurement 174. The comparer 164 may determine whether the filter should be changed based on the deviation. For example, if the deviation satisfies a threshold, the comparer may determine that the filter should be changed.

The operation control component 150 may include a notification component 166 that generates a notification regarding the status of the filter 130 based on the deviation of the measurement of the blower property from the baseline measurement 174. For example, the status notification may indicate that the filter 130 should be changed, for instance, because the condition of the filter 130 is reducing efficiency of the HVAC unit 110 or the filter 130 has become clogged. The status notification may be provided to a user via the communications component 112. For example, the notification may be sent to the remote user device 180 for display as the notification 190. The notification 190 may be, for example, a text message, an email, or a notification within the HVAC application 182.

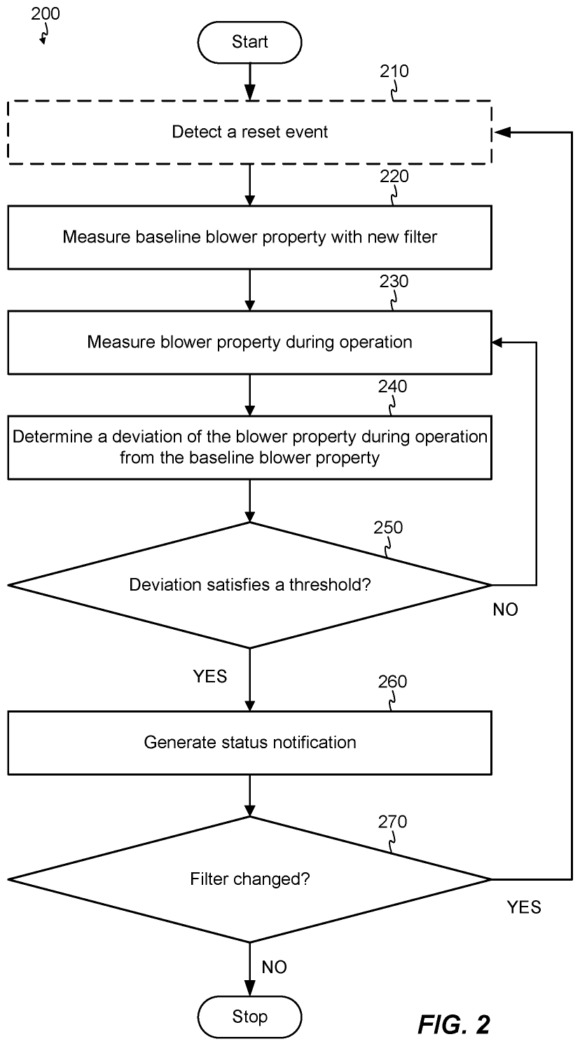

FIG. 2 is a flowchart of an example method 200 for generating a status notification for a climate control system. The method 200 may be performed by the controller 120 executing the operation control component 150.

At block 210, the method 200 may optionally include detecting a reset event. In an aspect, for example, the filter tracking component 170 may detect the reset event as a reset signal 172. The reset signal 172 may be generated by a reset event such as, for example, a press of a button on the controller (e.g., on user interface 4xx), a command from an application that displays the status notification to a user (e.g., HVAC application 182), or a detected filter change (e.g., a sensor associated with filter 130).

At block 220, the method 200 may include measuring a baseline blower property with a new filter. In an aspect, for example, the monitoring component 160 may measure the baseline measurement 174 with a new filter 130. For example, in response to the reset signal 172, the monitoring component 160 may measure the baseline blower property using the sensor information receiver 162. For example, the sensor information receiver 162 may receive sensor information from the sensor 129 associated with the blower 128. The sensor 129 may measure one or more properties of the blower 128 such as: blower wattage, pulse width of a blower control signal, blower current, blower speed, or blower run time.

At block 230, the method 200 may include measuring a blower property during operation. In an aspect, for example, the monitoring component 160 may measure the blower property during operation. The blower property may be measured during operation in the same manner used to measure the baseline measurement 174. That is, the monitoring component 160 may execute the sensor information receiver 162 to receive measurements from the sensor 129 associated with the blower 128. The measured property may be the same property as measured for the baseline measurement 174. The blower property may be measured periodically. For example, the blower property may be measured for every blower cycle, or may be measured after a preset number of blower cycles.

In an aspect, the system 100 may utilize preset operating programs for controlling the components of the HVAC unit 110. For example, the preset operating programs may be configured by an installer based on properties of the system 100. Each preset operating program may set a volume and a run time for the blower 128. The controller 120 may generate a pulse width modulated (PWM) control signal for the blower 128 to meet the set volume (e.g., as detected by a pressure sensor). The monitoring component 160 may be configured to sample the sensor 129 based on the preset operating program. For example, the monitoring component 160 may take one or more measurements of the blower property during the run time of the blower 128 to determine an average blower property. The same measurements may be taken for the baseline measurement and each measurement during operation for consistency.

At block 240, the method 200 may include determining a deviation of the blower property during operation from the baseline blower property. In an aspect, for example, the monitoring component 160 may execute the comparer 164 to determine the deviation of the blower property during operation from the baseline measurement 174 of the blower property. The deviation may be based on the average blower property for one or more blower cycles. In an aspect, the deviation may be a percentage of the baseline measurement or a value of a unit of the baseline measurement. For instance, if the baseline measurement is a wattage, the deviation may be represented as a percentage change (e.g., an increase of 20 percent) or a number of watts (e.g., an increase of 30 watts).

In block 250, the method 200 may include determining whether the deviation satisfies a threshold. In an aspect, for example, the monitoring component 160 may execute the comparer 164 to determine whether the deviation satisfies the threshold. For example, the threshold may be defined in the same manner as the deviation. The threshold for any particular HVAC unit 110 may be determined by testing. For example, an HVAC unit 110 may be run for a lifetime (e.g., 3 months) of a filter 130 to determine the deviation of the blower property at the end of the lifetime, and the threshold may be set to the deviation. As another example, a filter 130 may be periodically checked to determine when the filter 130 should be changed, and the threshold set to the deviation of the blower property at the time the filter 130 should be changed. In another aspect, the threshold may be based on efficiency goals of the HVAC unit. For example, the threshold may be based on an increased wattage of 10% (which may indicate a corresponding decrease in blower efficiency). If the deviation does not satisfy the threshold, the monitoring component 160 may determine that the filter 130 is operating correctly and does not need to be changed. The method 200 may return to block 230 for normal operation. In contrast, if the deviation does satisfy the threshold, the monitoring component 160 may determine that the filter 130 should be changed. The method 200 may proceed to block 260.

In block 260, the method 200 may include generating a status notification. In an aspect, for example, the notification component 166 may generate the status notification. The status notification may indicate that the filter 130 should be changed. The notification component 166 may transmit and/or display the status notification. For example, the notification component 166 may transmit the status notification to the remote user device 180. The remote user device 180 may display the status notification as a text message, email message, or notification 190 within the HVAC application 182.

In block 270, the method 200 may include determining whether the filter has been changed. In an aspect, for example, the filter tracking component 170 may determine whether the filter has been changed based on a reset signal 172. For instance, the filter tracking component 170 may determine whether the reset signal 172 has been received from the reset button 192 of the HVAC application 182 on the remote user device 180 or from a reset button 332 on a user interface 310. If the filter has been changed, the method 200 may return to block 210. In an aspect, a reset event may not be generated when a filter 130 is replaced with a similar (e.g., same rating) filter. If the filter has not been changed, the blower sensor 129 may continue to detect blower properties that deviate from the baseline measurement and the notification component 166 may generate additional notifications (e.g., after a preset time period).

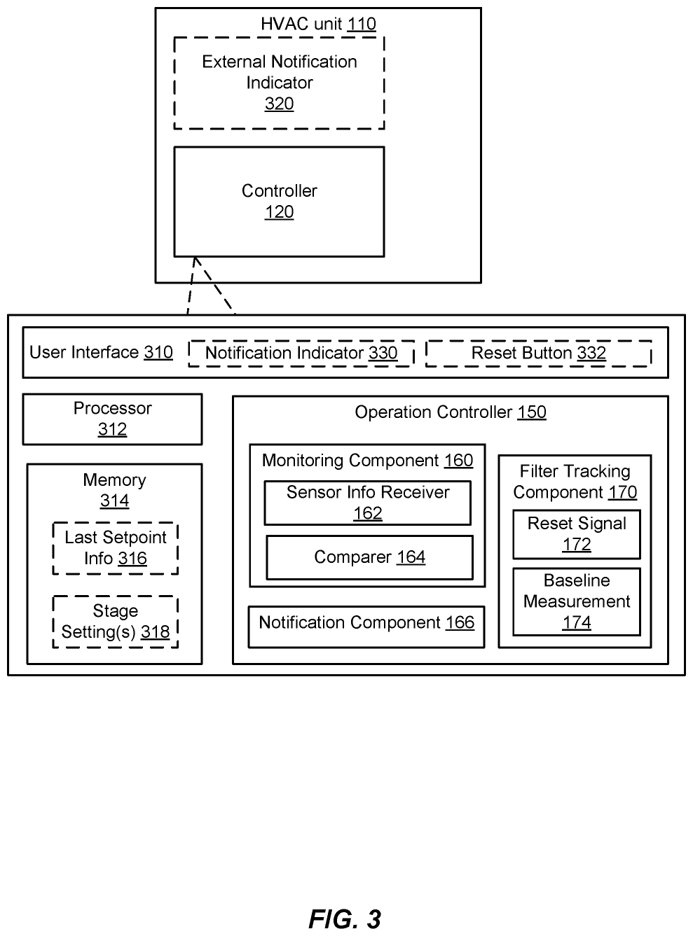

FIG. 3 is a more detailed view of a portion of the HVAC unit 110. In an aspect, the HVAC unit 110 may include an external notification indicator 320. The external notification indicator 320 may be, for example, a light (e.g., an LED) or liquid crystal display (LCD) that indicates a status of the filter 130. The notification component 166 may activate the external notification indicator 320 when generating the notification in response to the deviation from the baseline measurement 174.

In an aspect, the controller 120 may include a user interface 310. The user interface 310 may be, for example, a display that includes an input means such as a touch screen or associated buttons. The user interface 310 may include a notification indicator 330. The notification component 166 may activate the notification indicator 330 when generating the notification in response to the deviation from the baseline measurement 174. The user interface 310 may include a reset button 332. A user may activate the reset button 332 to generate the reset signal 172.

In an aspect, the controller 120 may include one or more processors 312 that execute instructions for performing one or more operations of the controller 120, as described herein. The controller 120 may include a memory 314 that stores the instructions executable by the one or more processors 312. The memory 314 may store parameters for operation of the controller 120. For example, the memory 314 may store last setpoint information 316, which may be a copy of the setpoint information 184 stored locally in case communication with the remote user device 180 is unavailable. The memory 314 may include stage settings 318 that define one or more preset operating programs for controlling the HVAC unit 110. For example, the stage settings 318 may include a blower runtime and/or blower air volume setting.

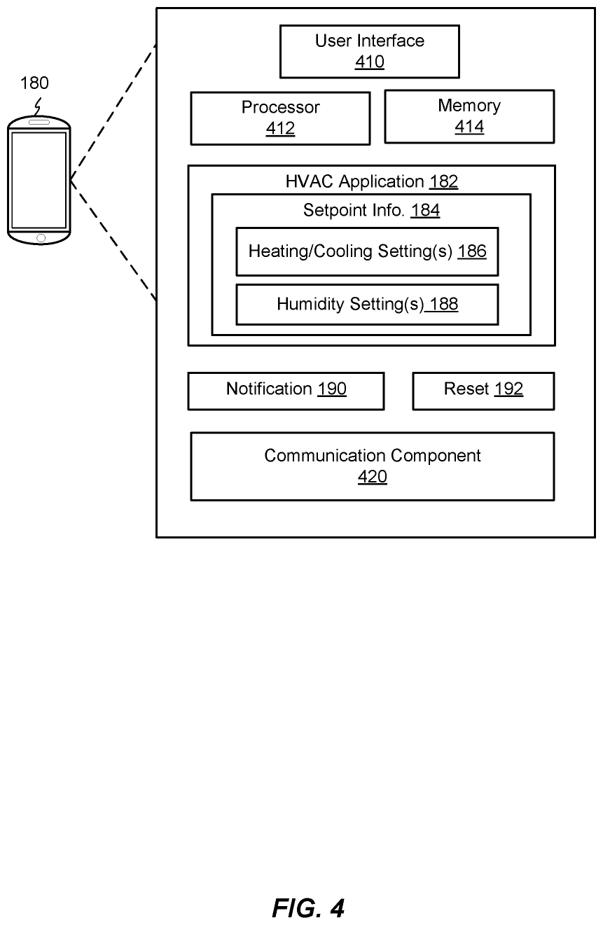

Turning to FIG. 4, the remote user device 180 may include a user interface 410, one or more processors 412, and memory 414. The user interface 410 may be, for example, a touch display that displays the HVAC application 182 and receives input from a user (e.g., via an on-screen keyboard). The processor 412 may execute instructions for the HVAC application 182. The memory 414 may store the HVAC application 182 and associated parameters. The remote user device 180 may include a communication component 420 such as a wireless modem that communicates with the controller 120 of the HVAC unit 110.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A climate control unit comprising:
a heat exchanger;
a blower that circulates air from an intake or return duct, across the heat exchanger, to a supply duct;
a filter that cleans air before entering the heat exchanger; and
a controller configured to:
set a baseline measurement of a blower property according to measurements of the blower property after a reset event;
measure a deviation of the blower property from the baseline measurement of the blower property; and
generate a status notification in response to the deviation satisfying a threshold.

2. The climate control unit of claim 1, wherein the reset event is in response to a user input to a button on the controller, a command from an application that displays the status notification to a user, or a detected filter change.

3. The climate control unit of claim 1, wherein the blower is configured with one or more preset operating programs and the deviation is measured based on operation during one of the preset operating programs.

4. The climate control unit of claim 3, wherein the controller controls the blower to move a preset volume of air during the one preset operating program.

5. The climate control unit of claim 1, wherein the blower property is one of: blower wattage, pulse width of a blower control signal, blower current, or blower speed.

6. The climate control unit of claim 1, wherein the threshold is a percentage of the baseline measurement or a number of units of the blower property.

7. The climate control unit of claim 1, further comprising a wireless modem configured to transmit the status notification to a remote user device associated with the climate control unit.

8. The climate control unit of claim 7, wherein the status notification is a text message, email, or notification for an application on the remote user device.

9. The climate control unit of claim 1, further comprising a display configured to display the status notification.

10. The climate control unit of claim 1, wherein the status notification indicates that the filter should be changed.

11. A method of controlling a climate control system including a blower, comprising:
setting a baseline measurement of a blower property according to measurements of the blower property after a reset event;
measuring a deviation of the blower property from the baseline measurement of the blower property; and
generating a status notification in response to the deviation satisfying a threshold.

12. The method of claim 11, wherein the reset event is in response to a user input to a button on a controller, a command from an application that displays the status notification to a user, or a detected filter change.

13. The method of claim 11, wherein the blower is configured with one or more preset operating programs, and wherein measuring the deviation is based on operation during a preset operating program.

14. The method of claim 13, wherein the blower is configured to to move a preset volume of air during the one or more preset operating programs.

15. The method of claim 11, wherein the blower property is one of: blower wattage, pulse width of a blower control signal, blower current, or blower speed.

16. The method of claim 11, further comprising transmitting the status notification to a remote user device associated with the climate control system.

17. The method of claim 11, further comprising displaying the status notification on a display of a climate control system controller.

18. The method of claim 11, wherein the status notification indicates that a filter should be changed.

19. A controller for a climate control system, comprising:
a memory storing computer-executable instructions;
a processor ocmmunicatively coupled to the memory to execute the instructions, wherein the processor is configured to:
set a baseline measurement of a blower property according to measurements of the blower property after a reset event;
measure a deviation of a blower property from a baseline measurement of the blower property; and
generate a status notification in response to the deviation satisfying a threshold.

20. The controller of claim 19, wherein the reset event is in response to a user input to a button on the controller, a command from an application that displays the status notification to a user, or a detected filter change.
